(19) United States
(12) Patent Application Publication
(10) Pub. No.: US 2021/0281543 A1
(43) Pub. Date: Sep. 9, 2021

(54) DYNAMIC Ipv6 ADDRESS PROBING METHOD BASED ON DENSITY

(71) Applicant: TSINGHUA UNIVERSITY, Beijing (CN)

(72) Inventors: Jiahai YANG, Beijing (CN); Guanglei SONG, Beijing (CN); Lin HE, Beijing (CN); Zhiliang WANG, Beijing (CN)

(21) Appl. No.: 17/192,016

(22) Filed: Mar. 4, 2021

(30) Foreign Application Priority Data
Mar. 9, 2020 (CN) 202010157916.3

(51) Int. Cl. H04L 29/12

(52) U.S. Cl. CPC H04L 61/6059; H04L 61/1511; H04L 61/2007

(57) ABSTRACT

The present disclosure discloses a dynamic IPv6 address probing method based on density. The method comprises the following steps: vectorizing active IPv6 seed addresses, then establishing a density space tree to learn high-density regions of seed addresses, finally generating possibly survivable IPv6 addresses in the high-density regions, and dynamically scanning target addresses. The method solves the problems that the 6Gen is too high in time complexity and the 6Tree limits the address probing range, meanwhile, the address probing efficiency is effectively improved, and the address probing time and economic cost are reduced.

### TECHNICAL FIELD

The present disclosure relates to the technical field of Internet technology, in particular, to a IPv6 address probing technology for next-generation Internet, namely, a dynamic IPv6 address probing method based on density.

### BACKGROUND ART

With the integrative development of network applications such as the Mobile Internet, the Internet of Things, and the Industrial Internet, the global demand for IP addresses continuously and rapidly grow, IPv4 address resources have been exhausted, and the next-generation is Internet based on IPv6 has become a leading field for countries to promote the industrial revolution of new science technology and reconstitute the national competitiveness. IPv6 has a 128-bit address space, the huge address space causes the IPv6 address space cannot be detected throughout the whole network. It is an effective method for detecting IPv6 addresses, that collecting active IPv6 addresses as seed addresses, analyzing the structure and distribution character of the seed addresses, and generating potentially active IPv6 addresses as target addresses for address scanning, and narrowing the space of address probing.

Among the related technologies, Murdock et al. proposed a 6Gen algorithm based on density clustering. Hamming distance is introduced as a distance index between seeds, while assuming that active IPv6 addresses are more likely to exist in high density areas. Aggregation Hierarchical Clustering (AHC) is used to initially adopt each seed address as a clustering, and the clustering is greedily expanded while each clustering maintains the maximum density area and the minimum scale, to generate high-density address regions, and the clustering is ended until the density is less than the set threshold, finally, addresses generation are performed in the high-density regions. However, the 6Gen is too high (O(n³)) in time complexity when clustering seed addresses to be applied to a large-scale address space probing, which limits the address probing space; at the same time, among the generated target addresses, the proportion of active addresses is small, the address probing efficiency is low, so that waste a lot of probing resources.

Liu et al. proposed an algorithm for dynamically finding active addresses, namely, 6Tree. 6Tree regards an IPv6 address as a high-dimensional vector, and constructs an IPv6 address space tree for an address vector corresponding to a seed address in accordance with is the address hierarchy. The value variability of seed vector in different dimensions is estimated by the sequence that the empirical entropy of the dimension in which it exists becomes zero during the clustering process, and it provides a suggested search direction equivalent to the path from a child node to a root node. 6Tree learns the hierarchical structure characteristics of the seed addresses in linear time, and achieves a good probing effect. However, the 6Tree only considers the hierarchical characteristics of the IPv6 address, the constructed space tree cannot dynamically change according to newly found addresses. In a case that the number of generated target addresses remains unchanged, address generation is performed in the same address space for each time, which limits the space of the probing address and the probing resources. Meanwhile, among the generated target addresses, the proportion of active addresses is relatively low even though higher than that of 6Gen, therefore wasting a great quantity of probing resources.

In summary, in IPv6 address probing, although 6Gen and 6Tree improve the efficiency of address probing in a certain extent, 6Gen cannot be applied to a large-scale address space probing because 6Gen has a too high time complexity, for example, when the seed address is 5000, the time of training seed address is more than one day. 6Tree's ingenious design reduces the time complexity of training seed addresses, but only considering the address hierarchy limits the space for IPv6 address generation, and when repeatedly performing the address probing, the generated target address remains unchanged, so that wastes network probing resources. Meanwhile, the two methods have low address probing efficiency, and waste address probing resources.

Therefore, there is a great need for a new target address generation algorithm to solve the technical problems of low address is probing efficiency, too high time complexity of 6Gen, and the technical problem that 6Tree limits address probing range.

### SUMMARY

The present disclosure is intended to solve one of the technical problems in the related art at least in a certain extent.

Therefore, the purpose of the present disclosure is to provide a dynamic IPv6 address probing method based on density, which effectively improves the address probing efficiency and reduces the address probing time and economic cost.

To achieve the above purpose, an embodiment of the present disclosure provides a dynamic IPv6 address probing method based on density, which includes the following steps: step S1, vectorizing active IPv6 seed addresses to obtain high dimensional vectors; step S2, in linear time, constructing a density space tree according to the high dimensional vectors, finding high-density regions of the active IPv6 seed addresses in the density space tree; and step S3, generating target addresses in the high-density regions, and performing address dynamic generation in combination with an address probing feedback mechanism.

In the dynamic IPv6 address probing method based on density according to the embodiment of the present disclosure, an efficient address probing algorithm DET (Detective) is designed by combining density, information entropy and space tree, the DET finds the high-density regions of the seed addresses in linear time by constructing the density space tree, while maintaining the hierarchical characteristics of the address as much as possible, then performs address dynamic generation in combination with the address probing feedback mechanism in the high density regions, therefore solving the problems of 6Gen's too high time complexity and the problem that is 6Tree limits in address probing range, and at the same time, effectively improving the address probing efficiency and reducing the time and economic cost of address probing.

In addition, the dynamic IPv6 address probing method based on density according to the above embodiment of the present disclosure may also have the following additional technical features:

Furthermore, in an embodiment of the present disclosure, the step S1 further includes: converting the active IPv6 seed addresses into non-negative integers; converting the non-negative integers by using different granularity numbers, and taking a converted granularity number digital as the high dimensional vector, wherein the high dimensional vector has a dimension of 128/β, wherein β represents granularity number.

Furthermore, in an embodiment of the present disclosure, a root node of the density space tree represents a variable address space in which the whole active IPv6 address is located, and a leaf node represents high-density regions of the active IPv6 seed addresses.

Furthermore, in an embodiment of the present disclosure, in the step S2, using a dividing index at the minimum entropy dimension of the vectors to construct the density space tree, to find the high-density regions.

Furthermore, in an embodiment of the present disclosure, constructing the density space tree specifically includes: initializing a root node by using the high dimensional vectors; performing dividing hierarchical clustering to the root node, dividing in a dimension in which corresponding vectors have a minimum entropy, and generating child nodes, and at the same time, distributing subsets of the vectors generated at the dividing dimension by the high dimensional vectors corresponding to the root node to the corresponding child nodes, and stopping the dividing until the high dimensional vectors included in the is nodes to be divided is less than the preset threshold, and the constructing of the density space tree is completed.

Furthermore, in an embodiment of the present disclosure, during the clustering process, in a case that it exists a plurality of minimum entropies in the node to be divided, an address hierarchy structure needs to be considered, and the dividing is performed in a manner of from left to right, and a priority of generating child nodes in the left dimension is higher than that of the nodes on right.

Furthermore, in an embodiment of the present disclosure, during the clustering process, the number of stable dimensions of the node is less than or equal to a depth of the node in a space tree.

Furthermore, in an embodiment of the present disclosure, the step S3 further comprises:

generating the target addresses in the high-density regions to perform pre-scanning of address according to the target addresses;

performing feedback scanning to the active IPv6 seed addresses in combination with the address probing feedback mechanism, and guiding the active IPv6 seed addresses to perform address dynamic generation in the density space tree.

Additional aspects and advantages of the present disclosure will be partially provided in the following description, and partially will become obvious from the following description, or can be understood from the practice of the present disclosure.

### BRIEF DESCRIPTION OF DRAWINGS

The above and/or additional aspects and advantages of the present disclosure will be understood from the following descriptions of the embodiments in conjunction with the drawings, in which:

FIG. 1 is a flow chart of a dynamic IPv6 address probing method based on density according to an embodiment of the present disclosure.

FIG. 2 is a schematic view illustrating a constructing process of a density space tree in the step S2 according to an embodiment of the present disclosure, wherein α refers to the minimum number of the address vectors contained in a node.

### DETAILED DESCRIPTION

Hereinafter, embodiments of the present disclosure will be described in detail, examples of the embodiments are shown in the accompanying drawings. Throughout the drawings, same or similar reference numerals indicate same or similar elements or elements having same or similar functions. The embodiments described below with reference to the accompanying drawings are exemplary, and are intended to explain the present disclosure, but should not be interpreted as a limitation to the present disclosure.

A dynamic IPv6 address probing method based on density according to an embodiment of the present disclosure will be described below with reference to the accompanying drawings.

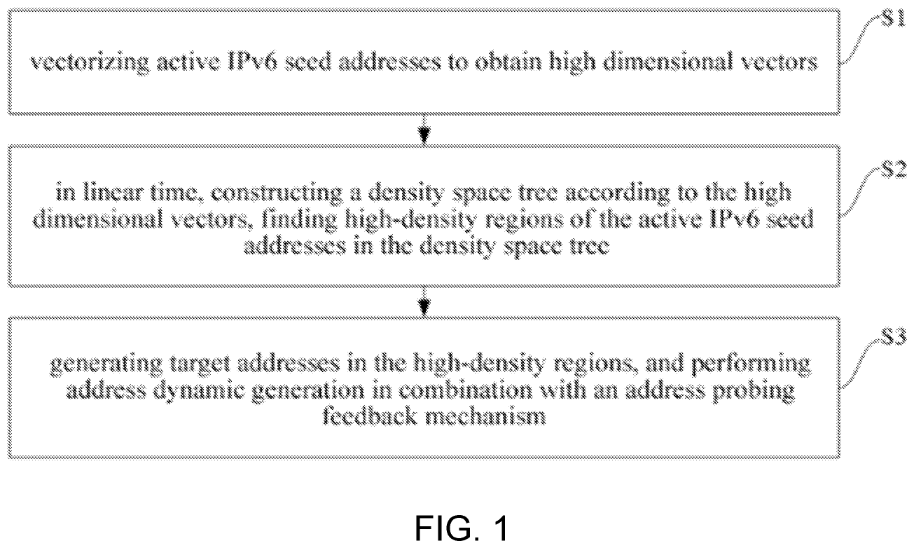

FIG. 1 is a flow chart of a dynamic IPv6 address probing method based on density according to an embodiment of the present disclosure.

As shown in FIG. 1, the dynamic IPv6 address probing method based on density includes the following steps:

Step S1, vectorizing active IPv6 seed addresses to obtain high dimensional vectors.

Furthermore, in an embodiment of the present disclosure, the step S1 further includes: converting the active IPv6 seed addresses into non-negative integers; converting the non-negative integers by using different granularity numbers, and taking converted granularity numbers digitals as the high dimensional vector, wherein the high dimensional vector has a dimension of 128/β, wherein β represents granularity number.

Specifically, the IPv6 address is a 128-bit binary symbol string, therefore it is necessary to redefine the active IPv6 seed addresses as high dimensional vectors, and express the active IPv6 seed addresses as different granularities (β). The specific implementation process is as follows: at first, converting the active IPv6 seed addresses expressed in binary into non-negative integers, then, using different granularities β to express, and taking converted 2^{β} granularity numbers digitals as the address vector. For example, the active IPv6 seed address is 2001:da8:abc:dfe::1, and when the granularities β=4, 32-dimensional expressed address vector is 20010da80abc0dfe0000000000000001; when β=2, a 64-dimensional expressed address vector is 0200000100312220002223300002333200000000000000000000000000 000001.

Step S2, constructing a density space tree according to the high dimensional vectors, and in linear time, finding high-density regions of the active IPv6 seed addresses in the density space tree.

A root node of the density space tree represents a variable address space in which the entire active IPv6 addresses are located, and a leaf node represents high-density regions of the active IPv6 seed addresses.

Furthermore, in an embodiment of the present disclosure, in the step S2, using a dividing index at the minimum entropy dimension of the vectors to construct the density space tree, so as to learn the high-density regions.

It should be noted that, using a dividing index divided at the minimum entropy dimension of the vectors of the seed addresses can avoid the high-density regions of the seed addresses from not being divided, so that the high-density regions of the seed addresses are distributed on the leaf nodes or on the same branch of the density space tree.

Furthermore, in an embodiment of the present disclosure, after the is seed addresses are vectorized, the root node is initialized by using the high dimensional vectors; the root node is subjected to dividing hierarchical cluster, and dividing is performed at the minimum entropy dimension of the corresponding vectors to generate child nodes; at the same time, subsets of the vectors generated at the dividing dimension by the high dimensional vector corresponding to the root node are distributed to the corresponding leaf nodes, and the dividing is stopped until the number of the high dimensional vectors included in the nodes to be divided is less than the preset threshold, and the construction of the density space tree is completed.

It should be noted that, during the clustering process, it is necessary to maintain the characteristics of address hierarchy for the density space tree as much as possible, therefore, in a case that it exists a plurality of minimum entropies in the node to be divided, the dividing is performed in a manner of from left to right in consideration of the address hierarchy structure, and the priority of generating child nodes in the left dimension is higher than that of the nodes on the right. And, each time a node is divided, the child node adds a stable dimension, therefore the clustering is performed according to the designed dividing hierarchical, and the number of stable dimensions of the node is less than or equal to the depth of the node in the space tree. For example, when the threshold of the number of vectors contained in the node is 1, the depth of the space tree is equal to the dimension of the IPv6 address vector.

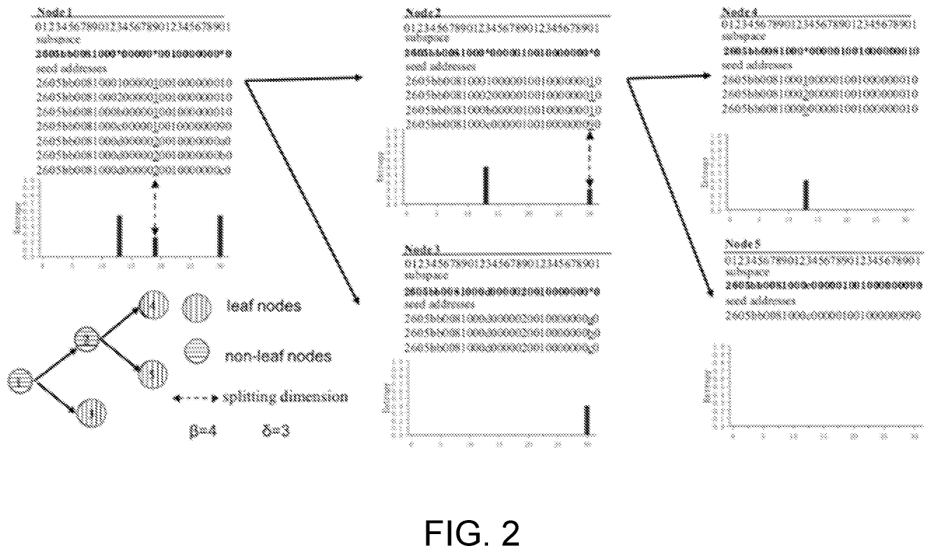

In addition, an embodiment of the present disclosure also uses a stack to record the order in which the entropy of dimension in the address vector becomes 0, therefore a node having only one child will incorporate into one node with the child node. The introduction of the stack in the node property firstly simplifies the structure of the space tree, in the meanwhile saves the consumption of the memory for storing is the density space tree. For example, as shown in FIG. 2, in the embodiment of the present disclosure, seven active IPv6 seed addresses are used to generate a density space tree comprising five nodes, wherein β=4 and α=3.

Furthermore, when high-density regions of seed addresses are found, a variety of data structures can be used to store the high-density regions of seed addresses. For example, nodes are maintained by using a queue. Initially, all seed addresses are set as root nodes and enter the queue. In each iteration, entropies of all variable dimensions in the current set are calculated, the dimension with the lowest entropy is selected, and the current set is divided according to the value of this dimension, the divided subsets are taken as the current nodes and enter the queue, then the divided node is then removed from the queue, finally, the regions maintained in the queue represents the high-density regions of seed addresses. The data structure of the storage node is only used to record the address density information, as long as the node is divided by using the minimum information entropy to find the high-density regions of seed addresses, they fall in the scope of the potential alternatives of the present disclosure.

In step S3, target addresses are generated in the high-density regions, and address dynamic generation is performed in combination with an address probing feedback mechanism.

Furthermore, in an embodiment of the present disclosure, the step S3 further includes:

generating the target addresses in the high-density regions to perform address pre-scanning according to the target addresses, performing feedback scanning on the active IPv6 seed addresses in combination with the address probing feedback mechanism, and guiding the active IPv6 seed addresses to perform address dynamic generation in the density space tree.

Specifically, the target addresses are generated in the high-density address space, and address is pre-scanned, then feedback scanning is performed to the active IPv6 seed addresses by using a 6Tree space tree dynamic generation tool, a direction in which the active IPv6 seed address is generated in the density space tree is guided, so as to further increase the proportion of generating an active IPv6 address and improve the IPv6 address space probing efficiency.

In summary, compared with related technology, the dynamic IPv6 address probing method based on density proposed in the embodiments of the present disclosure has the following advantages:

First, the embodiment of the present disclosure uses 2.3M globally active seed address to generate 50M target addresses, therefore the proportion for finding new active addresses increases to 32% in comparison with 16% of 6Gen and 18% of 6Tree.

Second, the time cost and economic cost for address probing are greatly reduced. As to the IPv6 address, it is found that, in the industry, a large number of probing packets are sent to scan active IPv6 addresses. However, current probing of active addresses takes a long time and has low efficient, resulting in waste of a lot of network resources (traffic). Increasing the IPv6 address probing ratio to 32% while clustering the seed addresses in linear time greatly reduces the probing time and reduces the consumption of network resources.

Third, the embodiment of the present disclosure promotes academic research in the fields of network measurement, network surveying and mapping, and network security and the like. Efficient IPv6 address probing technology establishes an active IPv6 address library to provide data support for the fields of network measurement, network surveying and mapping, and network security and the like.

Fourth, the embodiment of the present disclosure supports productizing of the industrial network measurement field and the is security field in the IPv6 network. Efficient address probing and scanning can collect a large number of active IPv6 addresses in a short time. Active IPv6 addresses support the promotion of network measurement industry products in the field of next-generation Internet, and further support the expansion of products of security companies in the IPv6 network.

Fifth, highly efficient IPv6 address probing and scanning is beneficial to grasping the network status of one's own IPv6, ensuring national information network security, and occupying the commanding heights and initiative of network security. Highly efficient IPv6 address probing and scanning is an important foundation for network attacks such as IPv6 network equipment and service identification and positioning, vulnerability discovery, and penetration testing. From a defense perspective, critical information infrastructures such as current Mobile Internet, Internet of Things, and Industrial Internet are more urgent for the construction and application of IPv6 and face higher risks; once it is attacked, it will have a significant impact on the social economy, and national economy and people's livelihood. By means of address probing, it is possible to grasp the address IPv6 network security status timely, avoid risks and defend against attacks. From a attack perspective, perceiving the opponent's IPv6 network topology and key nodes and seizing the IPv6 information advantages have important economic and national defense worth.

In addition, the terms “first” and “second” are only used for descriptive purposes and cannot be understood as indicating or implying relative importance or implicitly indicating the number of indicated technical features. Therefore, the features defined with “first” and “second” may explicitly or implicitly include at least one of the features. In the description of the present disclosure, unless otherwise specifically defined, “a plurality of” means at least two, for is example, two, three, etc.

In the description of the Specification, descriptions with reference to the terms “one embodiment”, “some embodiments”, “example”, “specific example” or “some examples” etc. mean that specific features, structures, materials or characteristics described in conjunction with the embodiment or example are included in at least one embodiment or example of the present disclosure. In the specification, schematic statements of the above terms do not necessarily refer to the same embodiment or example. Moreover, the described specific features, structures, materials or characteristics may be combined in any one or more embodiments or examples in a suitable manner. In addition, those skilled in the art can combine or incorporation the different embodiments or examples and features thereof described in the Specification in a case that they are not mutual contradiction.

Although the embodiments of the present disclosure have been shown and described above, it will be understood that the above embodiments are exemplary and should not be interpreted as a limitation to the present disclosure. Those skilled in the art can make changes, modifications, substitutions and variations to the above embodiments within the scope of the present disclosure.

What is claimed is:

1. A dynamic IPv6 address probing method based on density, comprising:
step S1, vectorizing active IPv6 seed addresses to obtain high dimensional vectors;
step S2, during a linear time, constructing a density space tree according to the high dimensional vectors, finding high-density regions of the active IPv6 seed addresses in the density space tree; and
step S3, generating target addresses in the high-density regions, and performing address dynamic generation in combination with an address probing feedback mechanism.

2. The dynamic IPv6 address probing method based on density according to claim 1, wherein the step S1 further comprises:
converting the active IPv6 seed addresses into non-negative integers;
converting the non-negative integers by using different granularity numbers, and taking the converted granularity numbers digits as the high dimensional vectors, wherein the high dimensional vectors have a dimension of 128/β, wherein β represents granularity numbers.

3. The dynamic IPv6 address probing method based on density according to claim 1, wherein a root node of the density space tree represents a variable address space where the whole active IPv6 addresses are located, and a leaf node of the density space tree represents high-density regions of the active IPv6 seed addresses.

4. The dynamic IPv6 address probing method based on density according to claim 1, wherein, in the step S2, using a dividing index in a dimension in which the vector has a minimum entropy to construct the density space tree, to find the high-density regions.

5. The dynamic IPv6 address probing method based on density according to claim 4, wherein constructing the density space tree comprises:
initializing a root node by using the high dimensional vectors;
performing dividing hierarchical clustering to the root node, dividing in a dimension in which corresponding vector has a minimum entropy, and generating child nodes, at the same time, distributing subsets of the vectors generated by the high dimensional vectors corresponding to the root node in a dividing dimension to corresponding child nodes, stopping the dividing until the number of the high dimensional vectors included in current nodes to be divided is less than a preset threshold, and the constructing of the density space tree is completed.

6. The dynamic IPv6 address probing method based on density according to claim 5, wherein during the clustering process, in a case that a plurality of minimum entropies exist in the node to be divided, an address hierarchy structure is considered, and the dividing is performed in a manner of from left to right, and a priority of generating child nodes in the dimension on left is higher than a priority of generating child nodes in the dimension on right.

7. The dynamic IPv6 address probing method based on density according to claim 5, wherein, during the clustering process, a stable dimension number of the node is less than or equal to a depth of the node in the space tree.

8. The dynamic IPv6 address probing method based on density according to claim 1, wherein the step S3 further comprises:
generating the target addresses in the high-density regions to perform pre-scanning of addresses according to the target addresses;
performing feedback scanning on the active IPv6 seed addresses in combination with the address probing feedback mechanism, and guiding the active IPv6 seed addresses to perform address dynamic generation in the density space tree.
